(19) United States
(12) Patent Application Publication
(10) Pub. No.: US 2007/0150639 A1
(43) Pub. Date: Jun. 28, 2007

(54) Multiple-interface connection port

(75) Inventor: Chien-Yuan Chen, Banchiau City (TW)

Correspondence Address: TROXELL LAW OFFICE PLLC;SUITE 1404, 5205 LEESBURG PIKE, FALLS CHURCH, VA, 22041, US

(73) Assignee: Power Data Communications Co., Ltd. & Chien-Yuan CHEN

(21) Appl. No.: 11/315,367

(22) Filed: Dec. 23, 2005

(51) Int. Cl. G06F 13/20

(52) U.S. Cl. 710/313

(57) ABSTRACT

A connection port includes a first terminal set of USB specification and a second terminal set of multi-transmission interface specification which are combined into a common bus conforming to a specification of USB junction, so as to constitute a multiple-interface connection port structure which can perform a signal transmission between an applied device and a connected multiple-interface storage carrier or peripheral equipment of USB specification, through this single common bus.

### BACKGROUND OF THE INVENTION

(a) Field of the Invention

The present invention relates to a signal connection port and more particularly to a multiple-interface connection port which can perform a signal transmission with a connected multiple-interface storage carrier or peripheral equipment with a USB (Universal Serial Bus) format through a single common bus.

(b) Description of the Prior Art

As the market of small size digital equipment (such as a digital camera, a camcorder, an MP3 player, a mobile phone, etc.), is getting more and more prosperous, its interior key elements will be directly affected. To correspond with a miniaturization and sophistication of these kinds of products, the development of technology of key elements is also toward miniaturization and chip design, and the circuit board used for configuring these mini IC (integrated circuit) elements is also getting smaller and smaller, while its density is getting higher and higher.

Accordingly, a digital storage carrier such as a memory card (e.g., Smart Media Card, Secure Digital Card, Multi Media Card, Memory Stick Card, Compact Flash Card, extreme Digital Picture card, etc.) or a personal disk used for storing video clips, digital pictures, MP3 music and game data for the aforementioned small size digital equipment has become the personal belonging of many computer users. Comparing to a disk, the memory card and personal disk are smaller in size, whereas they have a much larger capacity and a faster access speed. Moreover, these two storage carriers are not easily got wet or damaged like the disks, thereby allowing many consumers to replace the disks with these two storage carriers for carrying.

Referring to FIG. 1, as transmission interfaces used for connecting a personal disk A and a memory card B on a circuit board E are not the same; the transmission interface for the personal disk A is a USB connector 10, whereas the transmission interface for the memory card B is a conduction terminal 20 which is also called the golden finger. Therefore, the circuit board E should be installed with two interfaces corresponding to a USB connection port C and a memory card connector D respectively, which is rather inconvenient in application.

Accordingly, if a multiple-interface storage carrier can be constituted by combining the memory card transmission interface and the USB transmission interface into a junction which is complied with a USB specification, only a connection port corresponding to the common bus is required for connecting to applied electronic devices, so as to achieve the objects of saving a circuit board space, simplifying a circuit layout and assembling, improving an overall reliability, and reducing an inventory and a cost of logistics. Therefore, the multiple-interface storage carrier is apparently becoming a digital storage device and a digital signal transmission mode which are provided with an extreme potential of development.

### SUMMARY OF THE INVENTION

Accordingly, the present invention is to combine a first terminal set conforming to a USB specification and a second terminal set conforming to a multi-transmission interface specification into a common bus which is in compliance with a USB junction specification, so as to constitute a multiple-interface connection port structure for connecting with a circuit of multiple-interface storage carrier through this single common bus, thereby satisfying a requirement of signal transmission between an applied device and the multiple-interface storage carrier or other peripheral equipment of the USB specification.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of application status of a conventional personal disk and a memory card.

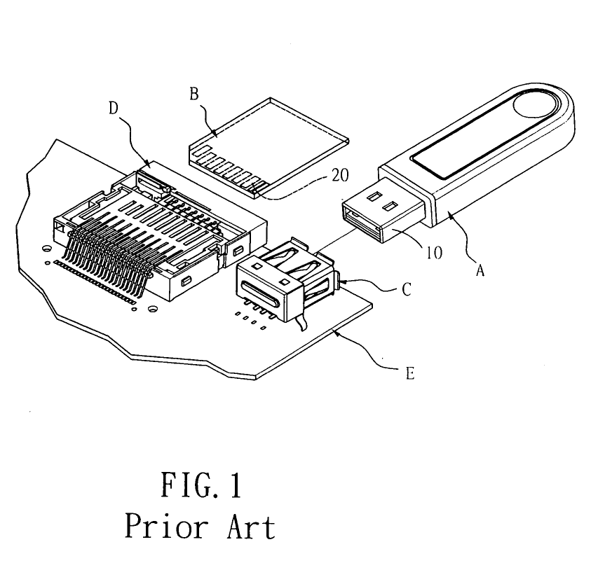

FIG. 2 shows a schematic view of application status of a multiple-interface connection port of the present invention.

FIG. 3 shows a cutaway view of status of connecting a multiple-interface connection port with a junction of multiple-interface storage carrier configuration of the present invention.

### DETAILED DESCRIPTION OF THE PREFERRED EMBODIMENTS

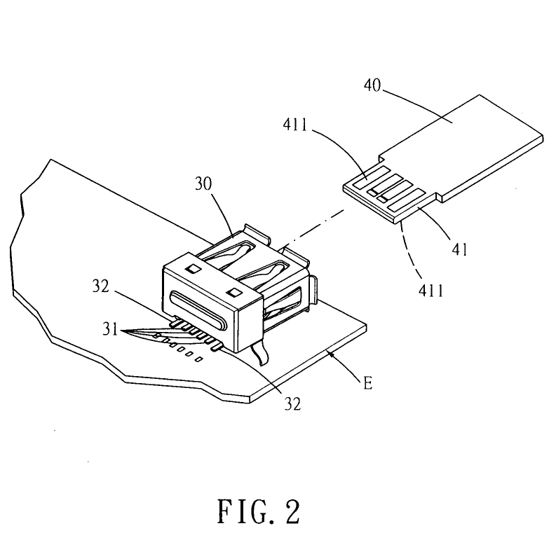

Referring to FIG. 2, a basic structure of entire multiple-interface connection port comprises primarily a common bus 30. Upon implementing, the common bus 30 can be further linked with a printer circuit board E (or a signal connection wire), wherein the common bus 30 includes a combination of a first terminal set 31 of USB specification and a second terminal set 32 of multi-transmission interface specification, so as to constitute a multiple-interface connection port structure linking with a circuit of multiple-interface storage carrier 40 through this single common bus 30.

A configuration pattern of circuit joints of the aforementioned first terminal set 31 is conforming to a corresponding pattern of USB connection port, which is primarily used to perform a data transmission between peripheral equipment of USB specification and a device applied with the multiple-interface connection port through the USB transmission interface. Some circuit joints of the second terminal set 32 are provided with a specified configuration pattern, and are primarily connected with the circuit joints of the first terminal set 31, so as to perform a data transmission between a multiple-interface storage carrier and a device applied with the multiple-interface connection port through a various kind of memory-card transmission interface.

Accordingly, the multiple-interface connection port of the present invention can satisfy a requirement of data transmission between the applied device and the multiple-interface storage carrier or other peripheral equipment of USB specification, so as to achieve the objects of saving a circuit board space, simplifying a circuit layout and assembling, improving an overall reliability, and reducing an inventory and a cost of logistics.

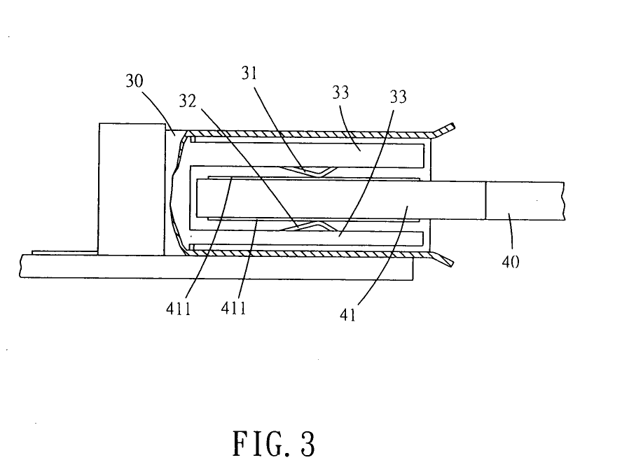

In a practical implementation, the first terminal set 31 and the second terminal set 32 can be installed on a substrate 33 inside the common bus 30, and be separately located at two corresponding positions, as shown in FIG. 3, in order to conform to a specification of multiple-interface storage carrier 40 that two board surfaces of a junction 41 are all provided with circuit joints 411.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A multiple-interface connection port comprising primarily a common bus which includes a combination of a first terminal set of USB specification and a second terminal set of multi-transmission interface specification.

2. The multiple-interface connection port according to claim 1, wherein the first terminal set and the second terminal set are separately located at two corresponding positions.
